(19) United States
(12) Patent Application Publication
(10) Pub. No.: US 2021/0334080 A1
(43) Pub. Date: Oct. 28, 2021

(54) DATA PARSING APPARATUS AND DATA PARSING METHOD

(71) Applicant: Institute For Information Industry, Taipei (TW)

(72) Inventors: Chih-Kai Chen, Taipei (TW); Yu-Chang Kuo, Taipei (TW)

(21) Appl. No.: 16/877,430

(22) Filed: May 18, 2020

(30) Foreign Application Priority Data
Apr. 27, 2020 (TW) 109114044

(51) Int. Cl. G06F 8/41; G06F 8/30

(52) U.S. Cl. CPC G06F 8/427; G06F 8/447; G06F 8/457; G06F 8/37

(57) ABSTRACT

In a data parsing method, a data adapter receives a piece of reference data, wherein the reference data has a data structure, the data structure includes at least one tag and a value corresponding to each of the at least one tag, and the reference data corresponds to a topic. The data adapter establishes a schema for the topic according to at least one path related to at least a portion of the at least one tag and the at least one value of the data structure. Referring to the schema, the data adapter uses a parser to parse a piece of objective data into a piece of parsed data, wherein the objective data has the data structure and corresponds to the topic.

### PRIORITY

This application claims priority to Taiwan Patent Application No. 109114044 filed on Apr. 27, 2020, which is hereby incorporated by reference in its entirety.

### FIELD

The present invention relates to a data parsing apparatus and a data parsing method. In particular, the present invention relates to a data parsing apparatus and a data parsing method for parsing structured data.

### BACKGROUND

In the field of data collection (e.g., data collection on cloud), it is usually the case that different types of terminal apparatuses store the collected data in different data structures. In order to integrate the data collected by different types of terminal apparatuses, a programmer has to understand the data structures adopted by different types of terminal apparatuses and then write the corresponding parsers for the different data structures so that the data collected by these terminal apparatuses can be parsed by the corresponding parsers.

Having a programmer (or programmers) write different parsers for different data structures is quite time-consuming. In addition, whenever a terminal apparatus adopting a new data structure is added to the current application field, the programmer has to learn the new data structure and then write a new parser so that the data collected by this newly added terminal apparatus can be pared by the new parser. Therefore, the more the types of terminal apparatuses for collecting data in an application field is, the higher the time cost required will be.

Accordingly, in the field of data collection, the technical problem that has to be conquered in the art is to reduce the time cost required for writing different parsers for diversified terminal apparatuses.

### SUMMARY

An objective is to provide a data parsing apparatus. The data parsing apparatus may comprise an interface and a processor which are electrically connected with each other. The interface may be configured to receive a piece of first reference data, wherein the first reference data has a first data structure, the first data structure comprises at least one tag and a value corresponding to each of the at least one tag, and the first reference data corresponds to a first topic. The processor may be configured to establish a first schema for the first topic according to at least one path related to at least a portion of the at least one tag and the at least one value of the first data structure. The processor may further parse a piece of first objective data into a piece of first parsed data by using a parser and referring to the first schema, wherein the first objective data is one of the first reference data and a piece of first data, and the first data has the first data structure and corresponds to the first topic.

Another objective is to provide a data parsing method. The data parsing method may comprise a step of receiving, by a data adapter, a piece of first reference data, wherein the first reference data has a first data structure, the first data structure comprises at least one tag and a value corresponding to each of the at least one tag, and the first reference data corresponds to a first topic. The data parsing method may comprise another step of establishing, by the data adapter, a first schema for the first topic according to at least one path related to at least a portion of the at least one tag and the at least one value of the first data structure. The data parsing method may further comprise another step of parsing, by the data adapter, a piece of first objective data into a piece of first parsed data by using a parser and referring to the first schema, wherein the first objective data is one of the first reference data and a piece of first data, and the first data has the first data structure and corresponds to the first topic.

For each distinct topic, the data parsing technology (at least including the apparatuses and the method) provided by the present invention individually establishes a corresponding schema according to the data structure of a piece of reference data of that topic. After a topic and the schema corresponding thereto are established, the data parsing technology provided by the present invention may use a parser and the schema of the topic to parse the data of the topic, no matter the data is from the same terminal apparatus or different terminal apparatuses. Please note that the data parsing technology provided by the present invention parses data of different topics by adopting the same parser but referring to the schemas of different topics. In this way, the data parsing technology provided by the present invention significantly reduces the time cost required for programmers to develop different parsers for different data structures.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts a schematic view and an application scenario of a data parsing apparatus according to a first embodiment;

FIG. 2A and FIG. 2B are schematic views depicting how the data parsing apparatus of the first embodiment performs data parsing;

FIG. 2C is a schematic view depicting a piece of reference data of the first embodiment;

FIG. 2D is a schematic view depicting a schema of the first embodiment;

FIG. 2E is a schematic view depicting a piece of parsed data of the first embodiment;

FIG. 2F is a schematic view depicting a schema of the first embodiment;

FIG. 2G is a schematic view depicting a piece of objective data of the first embodiment;

FIG. 2H is a schematic view depicting a piece of parsed data of the first embodiment; and

FIG. 3 is a flowchart depicting a data parsing method according to a second embodiment of the present invention.

### DETAILED DESCRIPTION

In the following description, a data parsing apparatus and method will be explained with reference to embodiments thereof. However, these example embodiments are not intended to limit the present invention to any specific environment, applications, examples, embodiments, or particular implementations described in these example embodiments. Therefore, description of these example embodiments is only for purpose of illustration rather than to limit the scope of the present invention. It shall be appreciated that, in the following embodiments and the attached drawings, elements unrelated to the present invention are omitted from depiction; and dimensions of and dimensional scales among individual elements in the attached drawings are provided only for illustration, but not to limit the scope of the present invention.

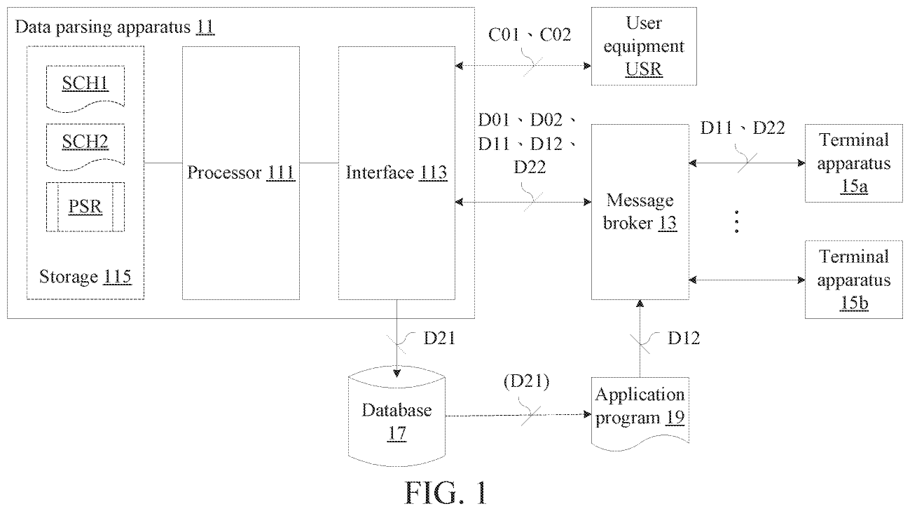

A first embodiment of the present invention is a data parsing apparatus 11, and a schematic view and an application scenario thereof are depicted in FIG. 1. It shall be appreciated that the content shown in FIG. 1 is only for illustration and is not intended to limit the scope of the present invention.

Referring to FIG. 1, the core of operations of this embodiment is the data parsing apparatus 11. The data parsing apparatus 11 may comprise a processor 111 and an interface 113, which are electrically connected with each other. The data parsing apparatus 11 may be one of various equipments with electronic computing capabilities (e.g., various computers and servers). One aspect of the data parsing apparatus 11 is a data adapter, and may be configured to parse input data and generate parsed data. The processor 111 may be one of various processors, Central Processing Units (CPUs), microprocessors, or other computing elements with the same or similar function and contemplated by a person having ordinary skill in the art. The interface 113 may be any wired or wireless interface capable of exchanging data with external apparatuses or elements.

The data parsing apparatus 11 may further comprise a storage 115. The storage 115 may be a memory, a mobile disk, a hard disk, or any other non-transitory storage media or device with the same function and well known to a person having ordinary skill in the art. The storage 115 may be configured to store data (e.g., a schema SCH1, a schema SCH2, which will be described in detail later) and programs (e.g., a parser PSR, which will be described in detail later) generated during the operation of the data parsing apparatus 11.

In this embodiment, an application scenario of the data parsing apparatus 11 may comprise a message broker 13, several terminal apparatuses 15a, . . . , 15b, a database 17, and a user equipment USR. Each of the terminal apparatuses 15a, . . . , 15b is an electronic apparatus with networking function(s) (e.g., mobile phones, tablet computers, notebook computers, and Internet of Things (IOTs) equipments, without being limited thereto). Each of the terminal apparatuses 15a, . . . , 15b corresponds to a topic, and periodically or non-periodically publishes data related to its topic to the message broker 13.

The message broker 13 is one of various apparatuses running intermediate program(s) that is capable of providing a message exchange function in a computer network. The message broker 13 receives data of different topics transmitted from the terminal apparatuses 15a, . . . , 15b, and users may subscribe to these topics through various apparatuses. If a user subscribes to a certain topic, then the message broker 13 will provide data of the topic to the user. For example, the message broker 13 may be ActiveMQ, RabbitMQ, or Kafka, without being limited thereto.

The database 17 may be a relational database, a non-relational database, a sequential database, or any other type of database that can be contemplated by a person having ordinary skill in the art. For example, the database 17 may be a “PostgresqlDB” database, a “MongoDB” database, or an “InfluxDB” database, without being limited thereto. The database 17 may be installed in the data parsing apparatus 11 or another apparatus with computing capability (e.g., one of various computers and servers). The user equipment USR may be an electronic apparatus (e.g., a mobile phone, a tablet computer, a notebook computer, without being limited thereto) that has a networking function and can be operated by a user.

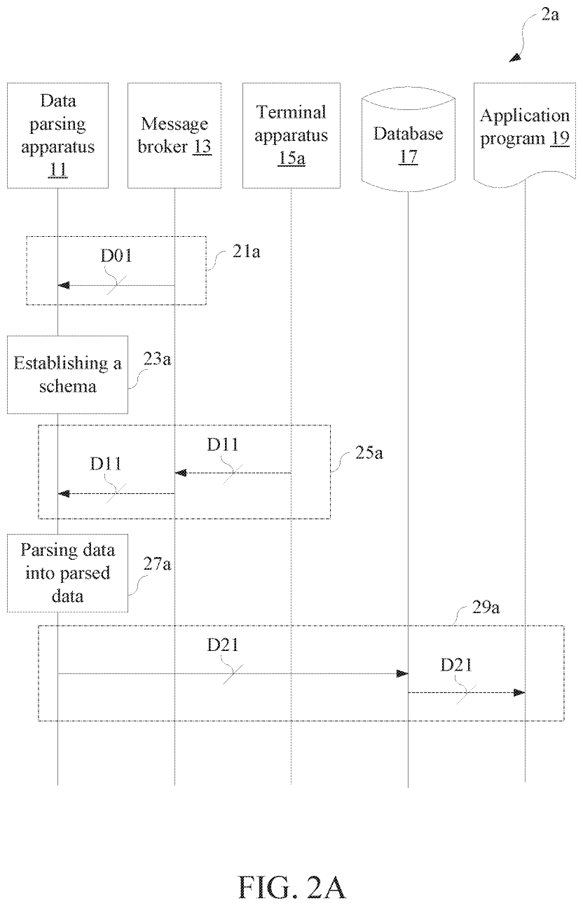

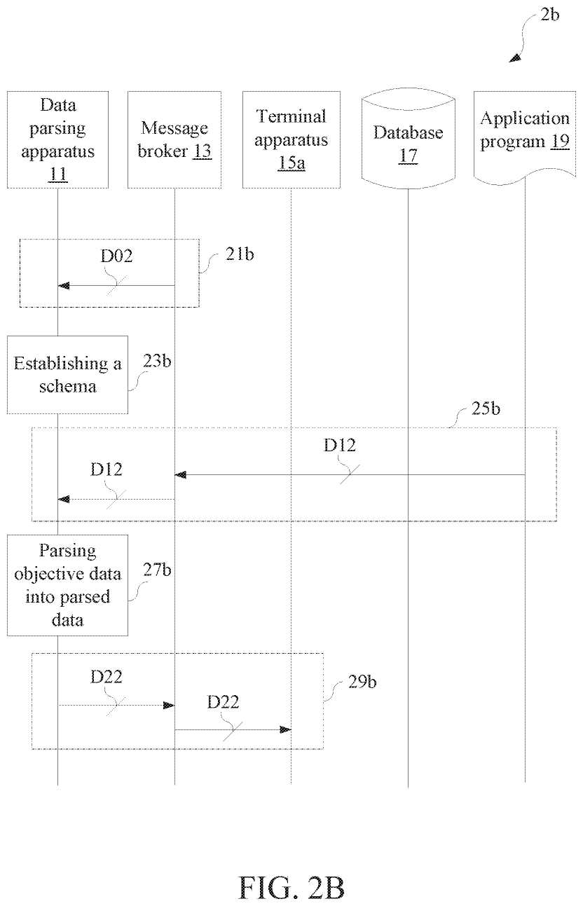

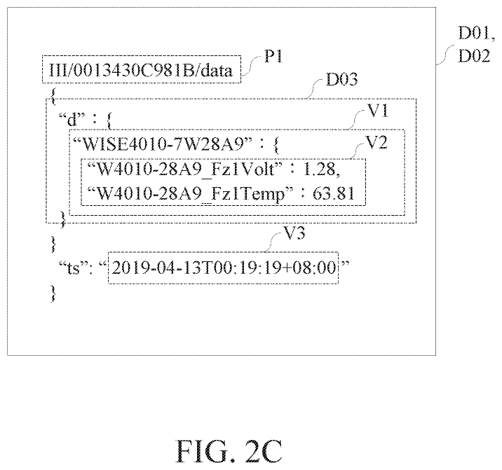

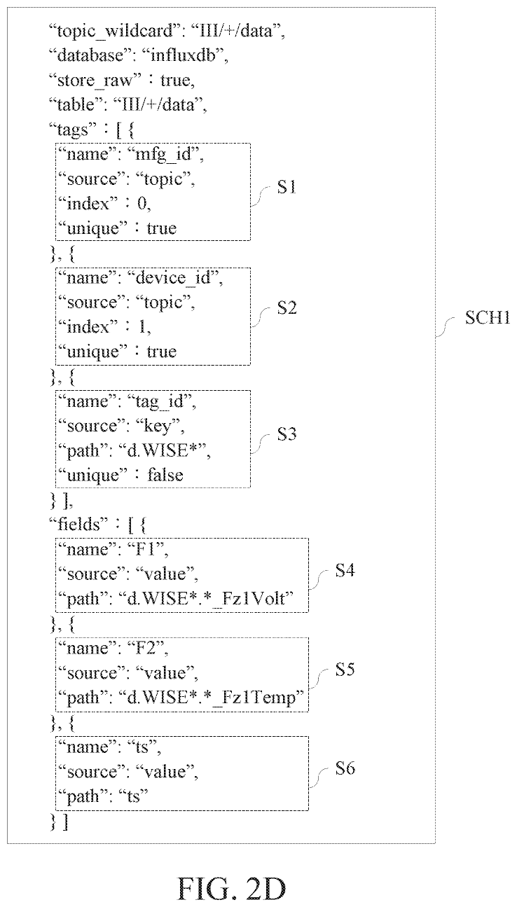

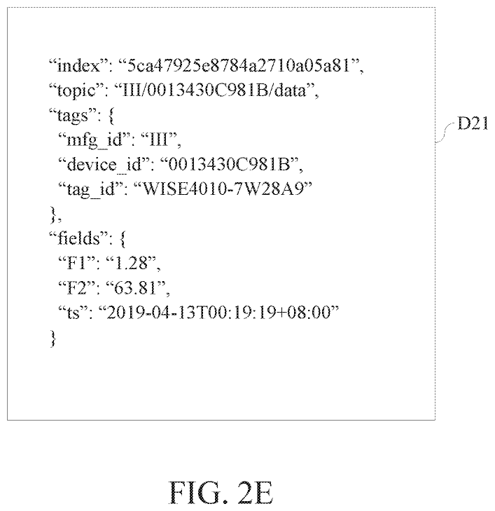

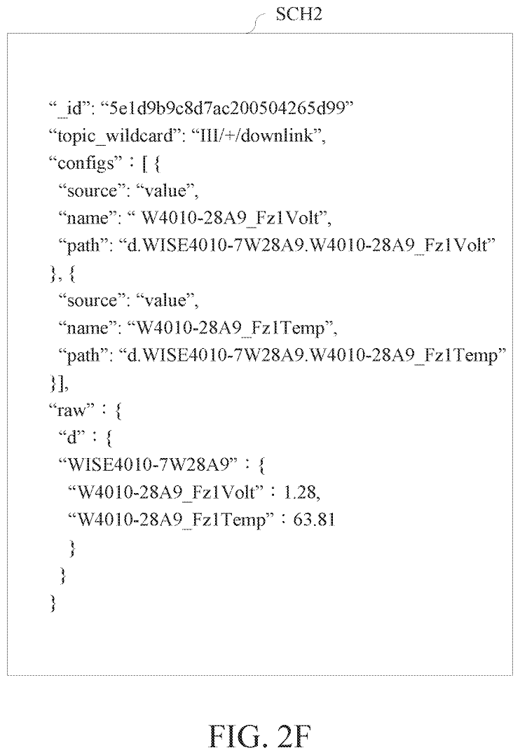

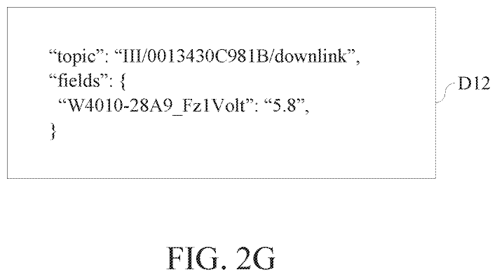

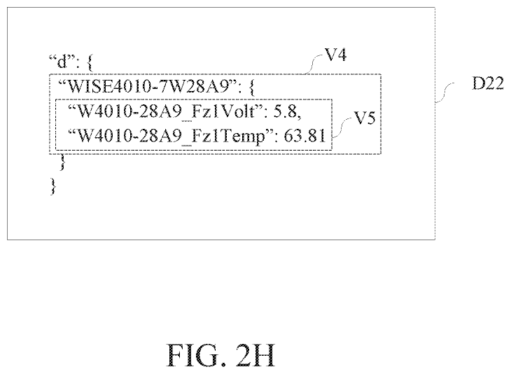

Next, the core of operations of this embodiment (i.e., the operations performed by the data parsing apparatus 11) will be described. Please refer to FIG. 2A and FIG. 2B, wherein FIG. 2A depicts the operations of the data parsing apparatus 11 for uplink data parsing, and FIG. 2B depicts the operations of the data parsing apparatus 11 for downlink data parsing. It shall be appreciated that the contents shown in FIG. 2A and FIG. 2B are only for illustration and are not intended to limit the scope of the present invention. In addition, in some embodiments, the data parsing apparatus 11 may only perform the operation of uplink data parsing or only perform the operation of downlink data parsing.

The operations of the data parsing apparatus 11 for uplink data parsing (i.e., the operation performed by the data parsing apparatus 11 when a user wants to obtain data of a certain topic through the data parsing apparatus 11 such as subscribing to data of a certain topic from the message broker 13 through the data parsing apparatus 11) will be described below with reference to FIG. 1 and FIG. 2A.

Here, it is assumed that the data parsing apparatus 11 has known that the user wants to subscribe to data of a certain topic (e.g., the interface 113 receives the message input by the user). In response to the subscription, the data parsing apparatus 11 obtains reference data D01 of the topic and then uses the reference data D01 to establish the schema SCH1 of the topic.

Specifically, the data parsing apparatus 11 may receive the reference data D01 of the topic from the message broker 13 through the interface 113 (operation 21a). The reference data D01 has a data structure, and the data structure comprises at least one tag and a value corresponding to each of the at least one tag. The reference data D01 may be data provided to the message broker 13 by a terminal apparatus corresponding to the topic (e.g., the terminal apparatus 15a), or it may be data stored in the message broker 13 in advance. In some embodiments, the reference data D01 may be a JSON file, an xml file, or a txt file.

Please refer to FIG. 2C for a specific example of the reference data D01, which, however, is not intended to limit the scope of the present invention. The reference data D01 in FIG. 2C is a JSON file, so its data structure is “key and value corresponding to each other”. In a JSON architecture, each key (which may be regarded as a tag) corresponds to a value, and a key is linked to its corresponding value by a colon “:”.

In the specific example shown in FIG. 2C, the topic corresponding to the reference data D01 is represented by a topic path “III/0013430C981B/data”. The topic path comprises three levels from high to low, of which the first level (the highest level) is “III”, the second level is “0013430C981B”, and the third level (the lowest level) is “data”. In addition, the data structure of the reference data D01 is hierarchical. Specifically, the first level comprises tags “d” and “ts”, the tag “d” comprises one second-level tag “WISE4010-7W28A9”, and the tag “WISE4010-7W28A9” comprises two third-level tags “W4010-28A9_Fz1Volt” and “W4010-28A9_Fz1Temp”.

As described above, each tag corresponds to one value. For example, the tag “d” corresponds to a value V1, i.e., all contents in the braces after the colon following the tag “d”. As another example, the tag “WISE4010-7W28A9” corresponds to a value V2, i.e., all contents in the braces after the colon following the tag “WISE4010-7W28A9”. For another example, the tag “W4010-28A9_Fz1Volt” corresponds to a value of “1.28”, the tag “W4010-28A9_Fz1Temp” corresponds to a value of “63.81”, and the tag “ts” corresponds to a value V3.

After the interface 113 receives the reference data D01 from the message broker 13, the processor 111 of the data parsing apparatus 11 establishes a schema SCH1 of the topic according to at least one path related to at least a portion of the at least one tag and the at least one value of the data structure (operation 23a). Please refer to FIG. 2D for a specific example of the schema SCH1 generated by the processor 111 based on the reference data D01, which, however, is not intended to limit the scope of the present invention. Please refer to FIG. 2C and FIG. 2D together for the following description.

The schema SCH1 may comprise an item “topic wildcard” for defining a source path “III/+/data” of the topic corresponding to the reference data D01. In this example, the processor 111 establishes the item “topic_wildcard” and the content thereof in the schema SCH1 according to the topic path P1 (whose content is “III/0013430C981B/data”) corresponding to the topic recorded in the reference data D01. In this example, the processor 111 replaces the second level in the topic path P1 with a wildcard character (i.e., the symbol “+”), which means that the second level in the source path is not limited. It shall be appreciated that, in other examples, the processor 111 may directly take the topic path P1 as the source path defined by the item “topic_wildcard” or replace the content(s) of other level(s) with the wildcard character, which will not be further described herein.

The schema SCH1 may comprise an item “database” for defining the type of the database, i.e., the type of the database for storing the parsed data generated by the processor 111 by parsing a piece of objective data (which will be described later) by using the parser PSR and referring to the schema SCH1 in the future. For example, the type of the database may be an “influxdb” database, a “mongodb” database, without being limited thereto. It shall be noted that, in the case of uplink data parsing, the processor 111 may select the “influxdb” database, the “mongodb” database, or other databases (if any) as the contents of the item “database”. In the case of downlink data parsing, the processor 111 may be preset to select the “mongodb” database or other databases as the contents of the item “database”. In this example, the content of the item “database” in the schema SCH1 established by the processor 111 is the “influxdb” database.

The schema SCH1 may comprise an item “store_raw” for defining whether to retain the original objective data after the processor 111 parses the objective data into a piece of parsed data with reference to the schema SCH1. For example, “true” may be used to indicate that the objective data should be retained, and “false” may be used to indicate that the objective data can be discarded. In this example, the content of the item “store_raw” in the schema SCH1 is “true”, so the processor 111 will retain the objective data after parsing a piece of objective data into a piece of parsed data with reference to the schema SCH1.

The schema SCH1 may comprise an item “table” for defining the name of the storage table for storing the parsed data generated by the processor 111 by parsing the objective data with reference to the schema SCH1. In this example, the content of the item “table” in schema SCH1 is “III/+/data”. If the schema SCH1 does not have the item “table”, the processor 111 may store the parsed data in a default table.

The schema SCH1 may comprise items “tags” and “fields”. The processor 111 establishes the items “tags” and “fields” according to the path(s) related to at least a portion of the tags and values in the data structure of the reference data D01, wherein the item “tags” records the portion related to the tags, and the item “fields” records the portion related to the values. The item “tags” may be further configured to record other information related to the tags, and the item “fields” may be further configured to record other information related to the values. By defining the items “tags” and “fields”, the processor 111 can then parse an object (i.e., a topic, a tag, or a value) in the objective data when parsing the objective data with reference to the schema SCH1. For example, the item “tags” may comprise attributes “name”, “source”, “index”, “path”, or/and “unique”, while the item “fields” may comprise attributes “name”, “source”, “index”, “path”, or/and “unique”.

The attribute “name” is configured to define the name of the field for storing an object, while the attribute “source” is configured to define the source of the object, e.g., the content of any level in the topic path P1, the key (i.e., tag), or the value. If the source of the object defined by the attribute “source” is a certain level in the topic path P1, then the attribute “index” may be configured to further define which level it is in the topic path P1. For example, the content of the attribute “index” may be a natural number, the number “0” represents the topmost level (i.e., the first level), and the number “1” represents the second level, and so on. If the source of the object defined by the attribute “source” is the “key (i.e., tag)” or “value”, then the attribute “path” may be configured to further define the path of the tag or the value. The content of the attribute “unique” may be a boolean value, wherein “true” indicates that the object is unique and “false” indicates that the object is non-unique.

In the example shown in FIG. 2D, the item “tags” comprises three sub-schemas S1, S2, and S3. The sub-schema S1 (whose content is {“name”: “mfg_id”, “source”: “topic”, “index”: 0, “unique”: true}) is defined by the processor 111 for the first level of the topic path P1 in the reference data D01. Specifically, the object processed by the processor 111 is the first level (i.e., “III”) of the topic path Pl, the parsed data corresponding to the object will be stored in the field “mfg_id”, and the object is unique.

In the example shown in FIG. 2D, the sub-schema S2 (whose content is {“name”: “device_id”, “source”: “topic”, “index”: 1, “unique”: true}) is defined by the processor 111 for the second level of the topic path P1 in the reference data D01.

Specifically, the object processed by the processor 111 is the second level of the topic path P1, the parsed data corresponding to the object will be stored in the field “device_id”, and the object is unique.

In the example shown in FIG. 2D, the sub-schema S3 (whose content is {“name”: “tag_id”, “source”: “key”, “path”: “d.WISE*”, “unique”: false}) is defined by the processor 111 for the tag “WISE4010-7W28A9” in the reference data D01. Specifically, the object processed by the processor 111 is the tag “WISE4010-7W28A9”, the parsed data corresponding to the object will be stored in the field “tag_id”, the path of the object is “d.WISE*”, and the object is non-unique. The attribute “path” in the sub-schema S3 uses the symbol “*” as a wildcard character, which represents any character and any string.

Therefore, the path “d.WISE*” comprises all tags that begin with “WISE” under the tag “d”.

In the example shown in FIG. 2D, the item “fields” comprises three sub-schemas S4, S5, and S6. The sub-schema S4 (whose content is {“name”: “F1”, “source”: “value”, “path”: “d.WISE*.*_Fz1Volt”}) is defined by the processor 111 for the value corresponding to the tag “W4010-28A9_Fz1Volt” in the reference data D01. Specifically, the parsed data corresponding to the object will be stored in the field “F1”, the path of the object is “d.WISE*.*_Fz1Volt”, and the source of the object is the value corresponding to the aforementioned path. The attribute “path” in the sub-schema S4 uses the wildcard character, so all paths whose first-level tag is “d”, second-level tag begins with “WISE”, and third-level tag ends with “_Fz1Volt” are included therein.

In the example shown in FIG. 2D, the sub-schema S5 (whose content is {“name”: “F2”, “source”: “value”, “path”: “d.WISE*.*_Fz1Temp”}) is defined by the processor 111 for the value corresponding to the tag “W4010-28A9_Fz1Temp” in the reference data D01. Specifically, the parsed data corresponding to the object will be stored in the field “F2”, the path of the object is “d.WISE*.*_Fz1Temp”, and the source of the object is the value corresponding to the aforementioned path. The attribute “path” in the sub-schema S5 uses the wildcard character, so all paths whose first-level tag is “d”, second-level tag begins with “WISE”, and third-level tag ends with “_Fz1Temp” are included therein.

In the example shown in FIG. 2D, the sub-schema S6 (whose content is {“name”: “ts”, “source”: “value”, “path”: “ts”}) is defined by the processor 111 for the value corresponding to the tag “ts” in the reference data D01. Specifically, the parsed data corresponding to the object will be stored in the field “ts”, the path of the object is “ts”, and the source of the object is the value corresponding to the aforementioned path.

As described above, in this embodiment, the processor 111 establishes the schema SCH1 of the topic according to at least one path related to at least a portion of the at least one tag and the at least one value of the data structure of the reference data D01, and may establish the schema SCH1 according to the topic path Pl.

In some embodiments, before the processor 111 establishes the schema SCH1 (operation 23a), the reference data D01 and information related to establishing the schema SCH1 may be provided to the user for confirmation. Only after the interface 113 receives at least one setting C01 provided by the user (e.g., through the user equipment USR) for the reference data D01 will the processor 111 establish the schema SCH1 according to the at least one setting C01. For example, a graphical user interface may be displayed on a display screen, the user may be guided to input settings corresponding to various attributes on the graphical user interface, and after the interface 113 receives the settings input by the user, the schema SCH1 will be established accordingly.

After establishing the schema SCH1, the processor 111 may parse the objective data of the same topic (and thus the same data structure) into a piece of parsed data D21 by using the parser PSR and referring to the schema SCH1 (operation 27a). It shall be noted that the parser PSR written by a programmer has the knowledge regarding the ways that the item “topic_wildcard”, the item “database”, the item “store_raw”, the item “table”, the item “tages”, the item “fields”, the attribute “name”, the attribute “source”, the attribute “index”, the attribute “path” and the attribute “unique” can be defined. Thus, as long as the schema is established based on the above defined rules, the parser PSR can understand the schema and parse the data corresponding to the schema.

The parser PSR may comprise a sub-parser for parsing uplink data and a sub-parser for parsing downlink data. If the parser PSR comprises the aforesaid two sub-parsers, then the corresponding sub-parser will be used for parsing depending on whether the current mode is an uplink mode or a downlink mode (for example, the current mode may be determined according to the source of the data to be parsed). For example, in an application scenario where the data parsing apparatus 11 subscribes to a certain topic from the message broker 13 to receive data corresponding to the topic, the data to be parsed is received from the message broker 13 based on the aforesaid subscription, and thus it is in the uplink mode and the sub-parser that parses the uplink data will be used for parsing the data. As another example, in some application scenarios, the data parsing apparatus 11 may receive the data to be parsed through an application program interface, and thus it is in the downlink mode and the sub-parser corresponding to the downlink mode will be used for parsing the data.

In this embodiment, the aforesaid reference data D01 is only used to establish the schema SCH1, and the processor 111 will not regard it as a piece of objective data for parsing. After the schema SCH1 is established, the data parsing apparatus 11 may assist, through the interface 113, the user in subscribing to the topic “III/+/data” from the message broker 13. After subscribing to the topic “III/+/data”, any terminal apparatus corresponding to the topic “III/+/data” will provide its data to the message broker 13 and the message broker 13 will relay the data to the data parsing apparatus 11 (operation 25a). In some embodiments, the data parsing apparatus 11 can receive data of the topic “III/+/data” from the message broker 13 without the need of subscribing to the topic from the message broker 13.

Thereafter, the processor 111 will regard each piece of data (e.g., data D11 shown in FIG. 2A) as a piece of objective data and parse the data into a piece of parsed data by using the parser PSR and referring to the schema SCH1 (operation 27a).

In some embodiments, the reference data D01 originates from a certain terminal apparatus corresponding to the topic “III/+/data”. Therefore, the processor 111 will regard the reference data D01 as a piece of objective data after establishing the schema SCH1 and parse the reference data D01 into a piece of parsed data by using the parser PSR and referring to the schema SCH1 (operation 27a).

A specific example is provided herein to facilitate understanding of the parsed data generated by the operation 27a, but it is not intended to limit the scope of the present invention. In this specific example, the reference data D01 is regarded as a piece of objective data, and the processor 111 parses the reference data D01 into the parsed data D21 as shown in FIG. 2E by using the parser PSR and referring to the schema SCH1.

The parsed data D21 comprises attributes “index”, “topic”, “tags”, and “fields”. The attribute “index” indicates the location or the index number of the parsed data D21 in the database. The attribute “topic” indicates that the topic corresponding to the parsed data D21 is “III/0013430C981B/data”. The fields “mfg_id”, “device_id”, and “tag_id” as well as the corresponding values “III”, “0013430C981B”, and “WISE4010-7W28A9” respectively are recorded in the attribute “tags”. The fields “F1”, “F2”, and “ts” as well as the corresponding values “1.28”, “63.81” and “2019-04-13T00:19:19+08:00” respectively are recorded in the attribute “fields”.

Referring to FIG. 2A, after the processor 111 parses the objective data into the parsed data D21, the interface 113 may transmit the parsed data D21 to the database 17 for storage. Various parsed data (e.g., the parsed data D21) stored in the database 17 may be accessed by the application program 19 for various applications (operation 29a). The application program 19 may be executed on the data parsing apparatus 11 or other apparatuses with computing capabilities (e.g., various computers and servers).

Although the above application scenario comprises the message broker 13, the message broker 13 may be omitted in some other application scenarios. In some other application scenarios, the data parsing apparatus 11 may receive the reference data D01 or the objective data directly from other apparatuses (e.g., terminal apparatuses) instead of receiving the reference data D01 or the objective data from the message broker 13. For example, the data parsing apparatus 11 may receive a HyperText Transfer Protocol (HTTP) request from a terminal apparatus through an uplink application programming interface (API), and the

HyperText Transfer Protocol request carries the reference data D01.

In some embodiments, the data parsing apparatus 11 may further perform the operations shown in FIG. 2A for different topics. How the data parsing apparatus 11 generates the corresponding schemas based on the reference data for different topics shall be appreciated by a person having ordinary skill in the art based on the above description, and thus will not be further described herein. It shall be appreciated that the reference data corresponding to different topics may have different data structures (but the data structure still comprises at least one tag and a value corresponding to each tag), so the schemas established by the processor 111 may be different. Please also note that although the schemas corresponding to different topics may be different, the processor 111 uses the same parser PSR to parse the data of different topics by referring to different schemas.

Next, the operations of the data parsing apparatus 11 for downlink data parsing (i.e., the operations that the data parsing apparatus 11 performs when it wants to change the data of the terminal apparatus of a certain topic) will be described with reference to FIG. 1 and FIG. 2B.

Specifically, the data parsing apparatus 11 may receive a piece of reference data D02 of the topic from the message broker 13 through the interface 113 (operation 21b). Similarly, the reference data D02 has a data structure, and the data structure comprises at least one tag and a value corresponding to each of the at least one tag. For ease of understanding, please refer to a specific example of the reference data D02 shown in FIG. 2C, but it is not intended to limit the scope of the present invention. It shall be appreciated that the reference data D02 used in the downlink data parsing and the reference data D01 used in the uplink data parsing may be the same or different depending on the need of the user. For example, a piece of reference data D03 shown in FIG. 2C may serve as the reference data for downlink data parsing, and it is a part of the reference data D01 (or the reference data D02).

After the interface 113 receives the reference data D02 from the message broker 13, the processor 111 of the data parsing apparatus 11 establishes a schema SCH2 of the topic according to at least one path related to at least a portion of the at least one tag and the at least one value of the data structure (operation 23b). How the processor 111 generates the schema SCH2 according to the reference data D02 in the “downlink data parsing” shall be appreciated by a person having ordinary skill in the art based on the description of generating the schema SCH1 in the “uplink data parsing”, and thus will not be further described herein.

Please refer to FIG. 2F for a specific example of the schema SCH2 generated by the processor 111 based on the reference data D02, but this specific example is not intended to limit the scope of the present invention.

In the specific example shown in FIG. 2F, the item “_id” is configured to define an identification code of the reference data D02. The item “topic wildcard” is configured to define the path (which is “III/+/downlink”) of the topic corresponding to the reference data D02. The item “configs” may comprise attributes “source”, “name”, and “path”. The attribute “source” may be configured to define the source of an object (e.g., a tag or a value). The attribute “name” may be configured to define the tag name to which the reference data corresponds after being parsed. The attribute “path” may be configured to define the path of the tag or the value. The attribute “raw” may be configured to define the raw data of the terminal apparatus 15.

Similarly, in some embodiments, before the processor 111 establishes the schema SCH2 (operation 23b), the reference data D02 and information related to establishing the schema SCH2 may be provided to the user for confirmation. Only after the interface 113 receives at least one setting CO2 provided by the user (e.g., through the user equipment USR) for the reference data D02 will the processor 111 establish the schema SCH2 according to the at least one setting C02.

After the processor 111 establishes the schema SCH2, the data parsing apparatus 11 may change the data of the terminal apparatus of the topic by referring to the schema SCH2. Specifically, the application program 19 provides the data D12 to the message broker 13 because it intends to modify a portion of the data D12, and the message broker 13 then provides the data D12 to the data parsing apparatus 11 (operation 25b).

Please refer to FIG. 2G for a specific example of the data D12, but this specific example is not intended to limit the scope of the present invention.

After the interface 113 receives the data D12, the processor 111 takes the data D12 as a piece of objective data. The processor 111 then parses the objective data into a piece of parsed data D22 by using the parser PSR and referring to the schema SCH2 (operation 27b). If the data D12 shown in FIG. 2G is taken as the objective data, then the parsed data D22 generated by the processor 111 may be as shown in FIG. 2H. In the example shown in FIG. 2H, the parsed data D22 comprises four keys (i.e., tags): “d”, “WISE4010-7W28A9”, “W4010-28A9_Fz1Volt”, and “W4010-28A9_Fz1Temp”. In addition, the key “d” corresponds to a value V4, the key “WISE4010-7W28A9” corresponds to a value V5, the key “W4010-28A9_Fz1Volt” corresponds to a value “5.8”, and the key “W4010-28A9_Fz1Temp” corresponds to a value “63.81”.

After the processor 111 parses the objective data into the parsed data D22, the interface 113 may transmit the parsed data D22 to the message broker 13 and then the message broker 13 relays the parsed data D22 to the terminal apparatus 15a (operation 29b) so that the terminal apparatus 15a modifies the data thereof according to the parsed data D22.

In some embodiments, the processor 111 may further define another topic for the parsed data D22 and then provide relevant information of the topic (e.g., the topic path) as well as the parsed data D22 to the message broker 13 for subscription by other users.

Similarly, although the above application scenario comprises the message broker 13, the message broker 13 may be omitted in some other application scenarios. In some other application scenarios, the data parsing apparatus 11 may receive the reference data D02 or the objective data directly from other apparatuses (e.g., terminal apparatuses) instead of receiving the reference data D02 or the objective data from the message broker 13. For example, the data parsing apparatus 11 may receive a HyperText Transfer Protocol request from a terminal apparatus through a downlink application programming interface, and the HyperText Transfer Protocol request carries the reference data D02 or the objective data. As another example, the data parsing apparatus 11 may also receive the reference data D02 or the objective data input by the user through a graphical user interface.

Similarly, in some embodiments, the data parsing apparatus 11 may further perform the operations shown in FIG. 2B for different topics. How the data parsing apparatus 11 generates the corresponding schemas based on the reference data for different topics shall be appreciated by a person having ordinary skill in the art depending on the above description, and thus will not be further described herein. It shall be appreciated that the reference data corresponding to different topics may have different data structures (but the data structure will still comprise at least one tag and the value corresponding to each tag), and therefore the schemas established by the processor 111 may be different. Please also note that although the schemas corresponding to different topics may be different, the processor 111 uses the same parser PSR to parse the data of different topics by referring to different schemas.

According to the above descriptions, the data parsing apparatus 11 may establish a schema corresponding to a topic according to a piece of reference data of the topic, no matter for uplink or downlink data parsing. After a topic and the schema corresponding thereto are established, the data parsing apparatus 11 parses the data of the topic by using the parser PSR and the schema of the topic, no matter the data is from the same terminal apparatus or different terminal apparatuses. For other topics, the data parsing apparatus 11 will also establish the schemas of the other topics in the same manner.

It shall be particularly noted that when parsing data of different topics, the data parsing apparatus 11 uses the same parser PSR to parse the data although with reference to different schemas. Comparing to the prior art that different specialized parsers have to be established for topics of different data structures, the data parsing apparatus 11 of the present invention only needs one single parser. Therefore, the time cost required for programmers to develop different parsers for different data structures is significantly reduced.

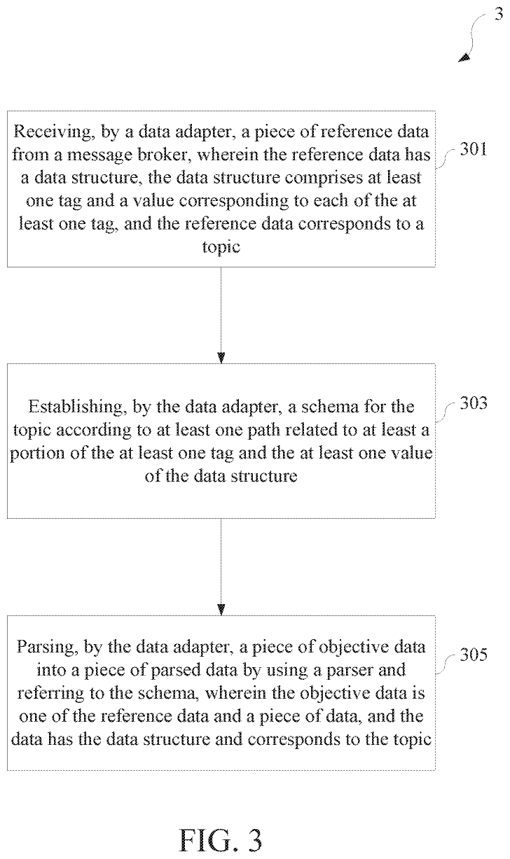

A second embodiment of the present invention is a data parsing method 3, and a flowchart thereof is depicted in FIG. 3. It shall be appreciated that the content shown in FIG. 3 is only for illustration and is not intended to limit the scope of the present invention. The data parsing method 3 is adapted for a data adapter (e.g., the data parsing apparatus 11 of the first embodiment), and the process flow of the data parsing method 3 will be described in detail below.

The data parsing method 3 comprises the steps 301, 303 and 305. In the step 301, the data adapter receives a piece of reference data, wherein the reference data has a data structure, the data structure comprises at least one tag and a value corresponding to each of the at least one tag, and the reference data corresponds to a topic.

In the step 303, the data adapter establishes a schema for the topic according to at least one path related to at least a portion of the at least one tag and the at least one value of the data structure. In some embodiments, the topic may correspond to a topic path and, thus, the data adapter may establish the schema by further according to the topic path in the step 303.

In some embodiments, the data parsing method 3 may further perform another step before the step 303, in which the data adapter receives at least one setting provided by a user for the reference data. In these embodiments, the step 303 establishes the schema according to the at least one setting by the data adapter.

In the step 305, the data adapter parses a piece of objective data of the topic into a piece of parsed data by using a parser and referring to the schema. In other embodiments, the data parsing method 3 may perform the step 305 for several times to individually parse other objective data of the topic into a piece of parsed data. It shall be appreciated that the objective data of the same topic has the same data structure. In addition, each of the objective data parsed in the step 305 is the actual data of the topic (e.g., data received from a certain terminal apparatus). Therefore, if the reference data received in the step 301 is the actual data of the topic, then the data parsing method 3 will also regard the reference data as a piece of objective data for parsing.

In some embodiments, each of the objective data and the reference data described above may be a JSON file, an xml file, or a txt file.

In some embodiments, the data parsing method 3 may be used for uplink data parsing or downlink data parsing.

First, some details of using the data parsing method 3 for uplink data parsing will be explained hereby. In the case of uplink data parsing, the embodiments may further comprise a step of subscribing, by the data adapter, to the first topic from a message broker to receive the first data from the message broker. In addition, in these embodiments, the objective data parsed in the step 305 is provided to the message broker by a terminal apparatus, and the message broker provides the objective data to the data adapter. Moreover, after the step 305, the data parsing method 3 may further comprise a step of transmitting the parsed data to a database by the data adapter.

Next, some details of using the data parsing method 3 for downlink data parsing will be explained. In the case of downlink data parsing, the objective data parsed in the step 305 is provided to the message broker by an application program, and the message broker provides the objective data to the data adapter. In addition, in these embodiments, after the step 305, the data parsing method 3 may further comprise a step of transmitting the parsed data to a terminal apparatus by the data adapter so that the terminal apparatus may perform corresponding operations according to the parsed data. In addition, in these embodiments, the data parsing method 3 may further comprise a step of defining a second topic for the first parsed data by the data adapter.

Similarly, although the application scenario of the aforesaid data parsing method 3 comprises a message broker, the message broker may be omitted in some other application scenarios. In those application scenarios where no message broker is included, the data adapter may directly receive reference data or objective data from other apparatuses (e.g., terminal apparatuses), and this will not be further described herein.

In some embodiments, the data parsing method 3 may further perform the steps 301 to 305 for other topics. How the data parsing method 3 generates the corresponding schemas based on the reference data for different topics shall be appreciated by a person having ordinary skill in the art based on the above description, and thus will not be further described herein. It shall be appreciated that the reference data corresponding to different topics may have different data structures (but the data structure still comprises at least one tag and a value corresponding to each tag), so the schemas established by the data parsing method 3 may be different. It shall be noted that although the schemas corresponding to different topics may be different, the step 305 uses the same parser to parse the data of different topics by referring to different schemas.

In some embodiments, the data parsing method 3 may be implemented in the data parsing apparatus 11. All corresponding steps comprised in the data parsing method 3 shall be clearly appreciated by a person having ordinary skill in the art according to the above description for the data parsing apparatus 11, and thus will not be further described herein.

In addition to the aforesaid steps, the second embodiment can also execute all the operations and steps of the data parsing apparatus 11 set forth in the first embodiment, have the same functions, and deliver the same technical effects as the first embodiment. How the second embodiment executes these operations and steps, have the same functions, and deliver the same technical effects as the first embodiment will be readily appreciated by a person having ordinary skill in the art based on the explanation of the first embodiment, and thus will not be further described herein.

For each distinct topic, the data parsing technology (at least including the apparatuses and the method) provided by the present invention can individually establish a corresponding schema according to the data structure of a piece of reference data of that topic. After a topic and the schema corresponding thereto are established, the data parsing technology provided by the present invention may use a parser and the schema of the topic to parse the data of the topic, no matter the data is from the same terminal apparatus or different terminal apparatuses. Please note that the data parsing technology provided by the present invention parses data of different topics by adopting the same parser but referring to the schemas of different topics. In this way, the data parsing technology provided by the present invention significantly reduces the time cost required for programmers to develop different parsers for different data structures.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. A data parsing apparatus, comprising:
an interface, being configured to receive a piece of first reference data, wherein the first reference data has a first data structure, the first data structure comprises at least one tag and a value corresponding to each of the at least one tag, and the first reference data corresponds to a first topic; and
a processor, being electrically connected to the interface, and being configured to:
establish a first schema for the first topic according to at least one path related to at least a portion of the at least one tag and the at least one value of the first data structure; and
parse a piece of first objective data into a piece of first parsed data by using a parser and referring to the first schema, wherein the first objective data is one of the first reference data and a piece of first data, and the first data has the first data structure and corresponds to the first topic.

2. The data parsing apparatus of claim 1, wherein the data parsing apparatus subscribes to the first topic from a message broker to receive the first data from the message broker.

3. The data parsing apparatus of claim 2, wherein:
the interface is further configured to receive a piece of second data, wherein the second data has the first data structure and corresponds to the first topic; and
the processor is further configured to parse the second data into a piece of second parsed data by using the parser and referring to the first schema.

4. The data parsing apparatus of claim 1, wherein:
the interface is further configured to receive a piece of third reference data, wherein the third reference data has a third data structure, the third data structure comprises at least one tag and a value corresponding to each of the at least one tag of the third data structure, and the third reference data corresponds to a third topic; and
the processor is further configured to:
establish a third schema for the third topic according to at least one path related to at least a portion of the at least one tag and the at least one value of the third data structure; and
parse a piece of third objective data into a piece of third parsed data by using the parser and referring to the third schema, wherein the third objective data is one of the third reference data and a piece of third data, and the third data has the third data structure and corresponds to the third topic.

5. The data parsing apparatus of claim 1, wherein:
the interface is further configured to receive the first data which originates from a terminal apparatus; and
the interface is further configured to transmit the first parsed data to a database.

6. The data parsing apparatus of claim 1, wherein:
the first data originates from an application program; and
the interface is further configured to transmit the first parsed data to a terminal apparatus.

7. The data parsing apparatus of claim 6, wherein:
the processor is further configured to define a second topic for the first parsed data.

8. The data parsing apparatus of claim 1, wherein:
the interface is further configured to receive at least one setting provided by a user for the first reference data; and
the processor establishes the first schema according to the at least one setting.

9. The data parsing apparatus of claim 1, wherein the first data is one of a JSON file, an xml file, and a txt file.

10. The data parsing apparatus of claim 1, wherein:
the processor is further configured to establish the first schema according to a topic path corresponding to the first topic.

11. A data parsing method, comprising the following steps:
receiving, by a data adapter, a piece of first reference data, wherein the first reference data has a first data structure, the first data structure comprises at least one tag and a value corresponding to each of the at least one tag, and the first reference data corresponds to a first topic;
establishing, by the data adapter, a first schema for the first topic according to at least one path related to at least a portion of the at least one tag and the at least one value of the first data structure; and
parsing, by the data adapter, a piece of first objective data into a piece of first parsed data by using a parser and referring to the first schema, wherein the first objective data is one of the first reference data and a piece of first data, and the first data has the first data structure and corresponds to the first topic.

12. The data parsing method of claim 11, wherein the data adapter subscribes to the first topic from a message broker to receive the first data from the message broker.

13. The data parsing method of claim 12, further comprising the following steps:
receiving, by the data adapter, a piece of second data from the message broker, wherein the second data has the first data structure and corresponds to the first topic; and
parsing, by the data adapter, the second data into a piece of second parsed data by using the parser and referring to the first schema.

14. The data parsing method of claim 11, further comprising the following steps:
receiving, by the data adapter, a piece of third reference data, wherein the third reference data has a third data structure, the third data structure comprises at least one tag and a value corresponding to each of the at least one tag of the third data structure, and the third reference data corresponds to a third topic;
establishing, by the data adapter, a third schema for the third topic according to at least one path related to at least a portion of the at least one tag and the at least one value of the third data structure; and
parsing, by the data adapter, a piece of third objective data into a piece of third parsed data by using the parser and referring to the third schema, wherein the third objective data is one of the third reference data and a piece of third data, and the third data has the third data structure and corresponds to the third topic.

15. The data parsing method of claim 11, further comprising the following steps:
receiving, by the data adapter, the first data which originates from a terminal apparatus; and
transmitting, by the data adapter, the first parsed data to a database.

16. The data parsing method of claim 11, wherein the first data originates from an application program, and the data parsing method further comprises the following step:
transmitting, by the data adapter, the first parsed data to a terminal apparatus.

17. The data parsing method of claim 16, further comprising the following step:
defining, by the data adapter, a second topic for the first parsed data.

18. The data parsing method of claim 11, further comprising the following step:
receiving, by the data adapter, at least one setting provided by a user for the first reference data;
wherein the data adapter establishes the first schema according to the at least one setting.

19. The data parsing method of claim 11, wherein the first data is one of a JSON file, an xml file, and a txt file.

20. The data parsing method of claim 11, wherein the data adapter further establishes the first schema according to a topic path corresponding to the first topic.
